(19) United States
(12) Patent Application Publication
(10) Pub. No.: US 2025/0112344 A1
(43) Pub. Date: Apr. 3, 2025

(54) BATTERY PACK

(71) Applicant: MURATA MANUFACTURING CO., LTD., Kyoto (JP)

(72) Inventors: Yasuhiro MATSUZAKI, Kyoto (JP); Yusuke TANJI, Kyoto (JP); Daiki NISHIIE, Kyoto (JP)

(21) Appl. No.: 18/816,795

(22) Filed: Aug. 27, 2024

(30) Foreign Application Priority Data
Sep. 29, 2023 (JP) 2023-170397

(51) Int. Cl. H01M 50/578; H01M 10/0525

(52) U.S. Cl. CPC H01M 50/578; H01M 10/0525

(57) ABSTRACT

A battery is provided and including a safety valve, in which the safety valve includes a first metal member positioned on an outer side, a second metal member positioned on an inner side, and an insulating member positioned between the first metal member and the second metal member, the first metal member and the second metal member are connected to each other so as to straddle the insulating member, and the first metal member has a stepped part including a thin portion having a thickness relatively reduced as compared with other portions.

### CROSS REFERENCE TO RELATED APPLICATIONS

The present application claims priority to Japanese patent application no. 2023-170397, filed on Sep. 29, 2023, the entire contents of which are incorporated by reference herein.

### BACKGROUND

The present disclosure relates to a battery.

The battery can extract energy due to chemical change or the like as electric energy, and is used for various applications. For example, the batteries are used in mobile devices such as mobile phones, smart phones, and notebook computers.

### SUMMARY OF THE INVENTION

The present disclosure relates to a battery. More specifically, the present disclosure relates to a battery including an electrode assembly made of an electrode-constituting layer including a positive electrode, a negative electrode, and a separator.

The safety of the battery is required. For example, a battery including a safety valve capable of achieving current interruption at the time of abnormality can be considered.

The inventors of the present application have studied and determined that there is still room for development of a safety valve for achieving current interruption at the time of abnormality in terms of interruption reliability.

The present disclosure, in an embodiment, relates to providing a battery having a characteristic with improved interruption reliability as a safety valve.

A battery according to the present disclosure, in an embodiment, includes:
a safety valve,
in which the safety valve includes a first metal member positioned on an outer side, a second metal member positioned on an inner side, and an insulating member positioned between the first metal member and the second metal member,
the first metal member and the second metal member are connected to each other so as to straddle the insulating member, and
the first metal member has a stepped part including a thin portion having a thickness relatively reduced as compared with other portions.

In the battery according to the present disclosure, current interruption at the time of abnormality can be more suitably achieved. For example, the outer first metal member provided in the safety valve has a stepped part formed of a thin form, and the interruption reliability of the safety valve of the battery is improved.

### BRIEF DESCRIPTION OF THE FIGURES

FIG. 1 is a schematic perspective view illustrating an appearance of a secondary battery according to an embodiment of the present disclosure;

FIG. 2 is a schematic view illustrating an internal configuration of the secondary battery according to an embodiment of the present disclosure;

FIG. 3 is a schematic perspective view illustrating constituent members and related members of a safety valve of the secondary battery according to an embodiment of the present disclosure in a developed state;

FIG. 4 is a schematic perspective view illustrating the constituent members of the safety valve of the secondary battery according to an embodiment of the present disclosure in a half and developed state;

FIG. 5 is a schematic perspective view illustrating the safety valve of the secondary battery according to an embodiment of the present disclosure in half;

FIG. 6 is a schematic sectional view of the safety valve of the secondary battery according to an embodiment of the present disclosure;

FIG. 7 is a schematic sectional view of the safety valve and a partial enlarged schematic view of a stepped part of the first metal member;

FIG. 8 is a schematic sectional view of a safety cover corresponding to the first metal member and a partial enlarged view thereof;

FIG. 9 is a schematic sectional view of the safety cover corresponding to the first metal member, a partial enlarged view thereof, and a partial enlarged contour view thereof;

FIG. 10 is a schematic sectional view of the safety cover corresponding to the first metal member and a top cover, a partial enlarged view thereof, and a partial enlarged contour view thereof;

FIG. 11 is a schematic sectional view of the safety valve and the first metal member and a second metal member constituting the safety valve;

FIG. 12 is a schematic sectional view and a partial enlarged schematic view of the safety valve for explaining a preferred exemplary embodiment of the present application;

FIG. 13 is a schematic sectional view illustrating a state of the safety valve before operation; and

FIG. 14 is a schematic sectional view illustrating a state of an operated safety valve.

### DETAILED DESCRIPTION

In recent years, along with a long life, a high output, and the like, performance improvement regarding reliability of a battery is required.

The inventors of the present application have found that a certain battery safety valve can achieve current interruption and the like at the time of abnormality and can cope with high output and the like, but still has room for development from another viewpoint. For example, the inventors of the present application have focused on the fact that a safety valve combined from a plurality of members is not necessarily satisfactory from the viewpoint of current interruption at the time of abnormality, and the member displacement due to an abnormal increase in battery internal pressure or the like may undesirably occur in some cases.

The safety valve of the battery can achieve current interruption and/or reduction of can internal pressure at the time of abnormality by cleaving or breaking the constituent members thereof. For example, in a battery provided with a safety valve including a combination of a safety cover, a stripper disk, and an insulating member therebetween, at least a groove provided in the safety cover acts, and pressure release can be achieved at the time of abnormality such as an increase in the battery internal pressure. That is, the safety cover subjected to the battery internal pressure at the time of abnormality is displaced and finally broken with the groove as a starting point, and pressure release is performed. However, during the verification of the safety valve, the inventor of the present application has noticed that current interruption does not necessarily suitably occur despite of a case where the intended pressure release is performed, and there is a case where current conduction is observed after the safety valve is cleaved.

In the safety valve, although a mechanism is assumed in which the safety cover is displaced so as to be bent when a stripper disk (for example, a stripper disk in which cleavage/breakage has occurred) moves outward (outward along the battery axis) under the battery internal pressure, it has been found that such a mechanism is not desired, and there is a case where unintended current conduction occurs after the safety valve is cleaved. In particular, the inventors of the present application have found that a spring back phenomenon or the like occurs with respect to displacement of the safety cover, and undesired current conduction may be also caused after breakage of the stripper disk and/or the safety cover.

The inventors of the present application have attempted to solve such a problem, for example, in a safety valve mechanism that operates in response to an abnormal increase in the battery internal pressure or the like, an undesirable displacement of the safety cover can be reduced or avoided, and furthermore, undesired conduction as the safety valve mechanism can be further reduced or avoided, leading to a more reliable battery.

Hereinafter, embodiments of the present disclosure will be described in further detail. It should be noted that the following description and examples for those skilled in the art to fully understand the present disclosure, and these are not intended to limit the subject matter described herein. That is, the present disclosure is not particularly limited thereto, and can be appropriately modified. Note that, in consideration of the description of the main points or ease of understanding, embodiments and the like may be separately described for convenience, but partial replacement and/or combination of configurations described in different embodiments and the like are possible. In the description of such an embodiment, descriptions of matters common to those described herein may be omitted, and only different points may be described. Particularly, similar functions and effects achieved by similar configurations may not be mentioned sequentially for each embodiment.

In the description of the present specification, reference to a direction, an orientation, or the like is merely for convenience of description, and is not intended to limit the scope of the present disclosure unless otherwise explicitly described. For example, relative terms, such as “out (or outer side, outer portion or outer circumference)”, “in (or inner side, inner portion or inner circumference)”, “bottom”, and the like, as well as derivative terms thereof, should be understood to refer to directions as described or illustrated. That is, unless otherwise explicitly described, the invention is not required to be limited only to a specific direction, orientation, form, or the like. In addition, terms such as “provided”, “disposed”, “connected”, and “adhered”, and derivative terms thereof are also similar, and are not limited to a direct mode, and may be a mode in which another element such as an inclusion is interposed unless otherwise explicitly described.

The term “battery” as used herein includes not only a so-called “secondary battery” but also a “primary battery” capable of only discharging. That is, the “battery” in the present specification may be a “secondary battery” that can be repeatedly charged and discharged, or a “primary battery” that is substantially only discharged. The “secondary battery” is not excessively bound by the name, and may include an “electric storage device”, for example.

Hereinafter, for convenience of description, the battery according to the present disclosure will be described in reference to a secondary battery as an example according to an embodiment.

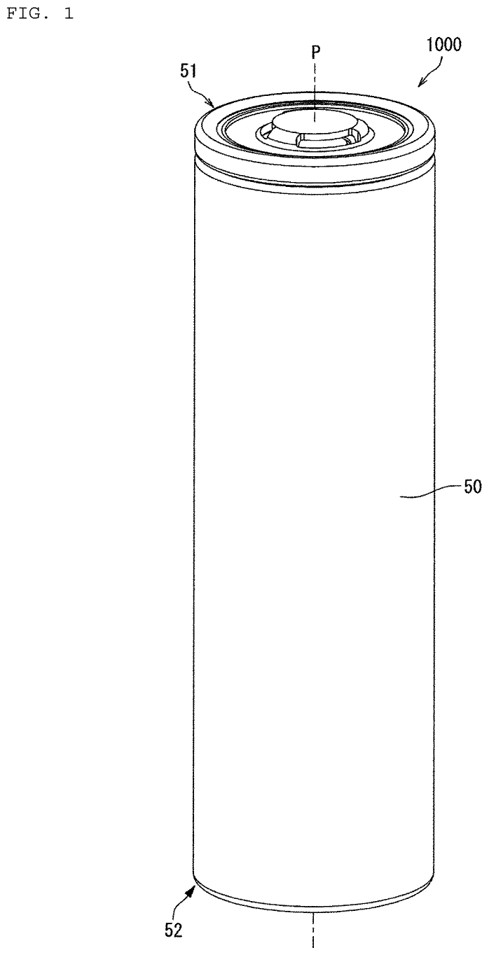

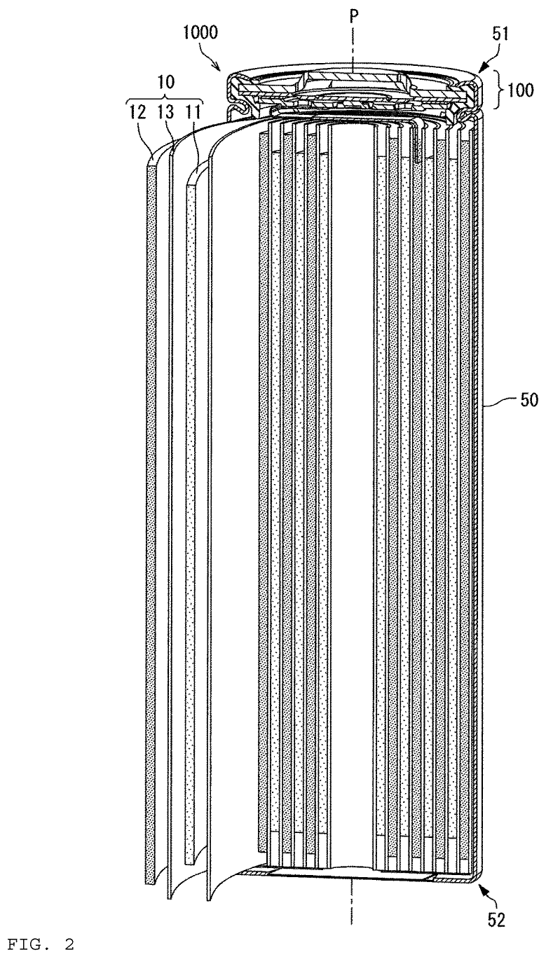

The secondary battery according to the present disclosure includes an electrode assembly formed of electrode-constituting layers, the electrode-constituting layers including a positive electrode, a negative electrode, and a separator. In the secondary battery according to the present disclosure, such an electrode-constituting layer may have a wound structure (hereinafter, also referred to as a “wound electrode body” or a “wound structure”) wound in a roll shape. FIG. 1 schematically illustrates an exemplary embodiment of an external appearance of a secondary battery 1000, and FIG. 2 schematically illustrates an exemplary aspect of an internal structure thereof. As illustrated in the drawing, the electrode assembly 10 is housed inside a battery can 50. In an embodiment illustrated in FIG. 2, an electrode assembly 10 has a configuration in which a positive electrode 11, a negative electrode 12, and a separator 13 disposed between the positive electrode and the negative electrode are wound. For the secondary battery 1000, such an electrode assembly 10 is enclosed together with an electrolyte (for example, a non-aqueous electrolyte) in the battery can 50.

The positive electrode is formed of at least a positive electrode material layer and a positive electrode current collector. In the positive electrode, the positive electrode material layer is provided on at least one surface of the positive electrode current collector. The positive electrode material layer contains a positive electrode active material as an electrode active material. For example, for each of a plurality of positive electrodes in the electrode assembly, the positive electrode material layer may be provided on both surfaces of the positive electrode current collector, or may be provided only on one surface of the positive electrode current collector.

The negative electrode is formed of at least a negative electrode material layer and a negative electrode current collector. In the negative electrode, the negative electrode material layer is provided on at least one surface of the negative electrode current collector. The negative electrode material layer contains a negative electrode active material as an electrode active material. For example, for each of a plurality of negative electrodes in the electrode assembly, the negative electrode material layer may be provided on both surfaces of the negative electrode current collector, or may be provided only on one surface of the negative electrode current collector.

The electrode active materials included in the positive electrode and the negative electrode, that is, the positive electrode active material and the negative electrode active material are substances directly involved in the transfer of electrons in the secondary battery, and are main substances of the positive and negative electrodes, which are responsible for charge-discharge, that is, a battery reaction. More specifically, ions are brought in the electrolyte due to the “positive electrode active material contained in the positive electrode material layer” and the “negative electrode active material contained in the negative electrode material layer”, and such ions move between the positive electrode and the negative electrode to transfer electrons, thereby performing charging and discharging. The positive electrode material layer and the negative electrode material layer may be layers particularly capable of occluding and releasing lithium ions. More specifically, the secondary battery according to the present disclosure may be a non-aqueous electrolyte secondary battery in which lithium ions move between the positive electrode and the negative electrode with a non-aqueous electrolyte interposed therebetween, thereby charging and discharging the battery. In a case where lithium ions are involved in charge and discharge, the secondary battery according to the present disclosure corresponds to a so-called “lithium ion battery”, and includes electrodes capable of occluding and releasing lithium ions as a positive electrode and a negative electrode, and preferably includes layers capable of occluding and releasing lithium ions.

In view of a lithium ion battery, the positive electrode active material may be a material that contributes to occlusion and release of lithium ions. That is, the positive electrode layer may contain any one kind or two or more kinds among positive electrode materials capable of occluding and releasing lithium. From such a viewpoint, the positive electrode active material may be, for example, a lithium-containing compound. The lithium-containing compound is not particularly limited in its type, and can be, for example, a lithium-containing composite oxide, a lithium-containing phosphate compound, or the like. This is because a high energy density can be obtained.

The lithium-containing composite oxide is a generic name of oxides containing lithium and one or more of other elements (elements other than lithium) as constituent elements, and may have, for example, one of crystal structures such as a layered rock-salt type crystal structure and a spinel type crystal structure. The lithium-containing phosphate compound is a generic name of phosphate compounds that contain lithium and one or more of the other elements as constituent elements, and may have, for example, a crystal structure such as an olivine crystal structure. The kind of the other element is not particularly limited as long as the element is any one or two or more of arbitrary elements. Among them, the other element is one or two or more of elements belonging to Groups 2 to 15 in a long-period periodic table. More specific examples of other elements are nickel (Ni), cobalt (Co), manganese (Mn) and iron (Fe). This is because a high voltage can be easily obtained.

The lithium-containing composite oxide having a layered rock salt type crystal structure may be compounds represented by the following respective Formulas (1) to (3).

LiₐMn_{(1-b-c)}Ni_{b}M11_{c}O_{(2-d)}Fₑ (1)
(M11 is at least one of cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), and tungsten (W). a to e satisfy 0.8≤a≤1.2, 0<b<0.5, 0≤c≤0.5, (b+c)<1, −0.1≤d≤0.2, and 0≤e≤0.1. However, the composition of lithium varies depending on the charged and discharged state, and a represents a value in a fully discharged state).

LiₐNi_{(1-b)}M12_{b}O_{(2-c)}F_{d} (2)
(M12 represents at least one of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), or tungsten (W). a to d satisfy 0.8≤a≤1.2, 0.005≤b≤0.5, −0.1≤c≤0.2, and 0≤d≤0.1. However, the composition of lithium varies depending on the charged and discharged state, and a represents a value in a fully discharged state).

LiₐCo_{(1-b)}M13_{b}O_{(2-c)}F_{d} (3)
(M13 represents at least one of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), or tungsten (W). a to d satisfy 0.8≤a≤1.2, 0≤b≤0.5, −0.1≤c≤0.2, and 0≤d≤0.1. However, the composition of lithium varies depending on the charged and discharged state, and a represents a value in a fully discharged state).
For example, specific examples of the lithium-containing composite oxide having a layered rock salt type crystal structure include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}COo_{0.175}Ni_{0.1}O₂, and Li_{1.15}(Mn_{0.65}Ni_{0.22}Co_{0.13})O₂.
In a case in which the lithium-containing composite oxide having a layered rock-salt crystal structure contains nickel, cobalt, manganese, and aluminum as constituent elements, the atomic ratio of nickel is preferably 50 atomics or more. This is because a high energy density can be obtained.

The lithium-containing composite oxide having a spinel type crystal structure may be a compound represented by the following Formula (4).

LiₐMn_{(2-b)}M14_{b}O_{c}F_{d} (4)
(M14 represents at least one of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), or tungsten (W). a to d satisfy 0.9≤a≤1.1, 0≤b≤0.6, 3.7≤c≤4.1, and 0≤d≤0.1. However, the composition of lithium varies depending on the charged and discharged state, and a represents a value in a fully discharged state).
As specific examples, the lithium-containing composite oxide having a spinel type crystal structure may be LiMn₂O₄ and the like.

Examples of the lithium-containing phosphate compound having an olivine type crystal structure include a compound represented by the following Formula (5).

LiₐM15PO₄ (5)
(M15 represents at least one kind of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W), or zirconium (Zr). a satisfies 0.9≤a≤1.1. However, the composition of lithium varies depending on the charged and discharged state, and a represents a value in a fully discharged state).
As specific examples, the lithium-containing phosphate compound having an olivine type crystal structure may be LiFePO₄, LiMnPO₄, LiFe_{0.5}Mn_{0.5}PO₄, LiFe_{0.3}Mn_{0.7}PO₄, and the like.

Incidentally, the lithium-containing composite oxide may be a compound represented by the following Formula (6).

(Li₂MnO₃)ₓ(LiMnO₂)₁₋ₓ (6)
(x satisfies 0≤x≤1. However, the composition of the lithium varies depending on the charged and discharged states, and x is a value of a perfectly discharged state).

In addition to these, the positive electrode material may be any one kind or two or more kinds among, for example, oxides, disulfides, chalcogenides, and conductive polymers. The oxide may be, for example, titanium oxide, vanadium oxide, manganese dioxide, or the like. Examples of the disulfide include titanium disulfide and molybdenum sulfide. The chalcogenide is, for example, niobium selenide or the like. The conductive polymer is, for example, sulfur, polyaniline, polythiophene, or the like. However, the positive electrode material is not particularly limited, and other materials other than the above materials may be used.

The positive electrode material layer may contain a binder. In addition, a positive electrode conductive agent may be contained in the positive electrode material layer in order to facilitate transmission of electrons promoting a battery reaction. The positive electrode binder contains, for example, any one or two or more types of synthetic rubbers and polymer compounds. The synthetic rubber is, for example, styrene-butadiene rubber, fluorine rubber, ethylene propylene diene, or the like. The polymer compound is, for example, polyvinylidene fluoride, polyimide, or the like. The positive electrode conductive agent may include, for example, any one of, or two or more of carbon materials. The carbon material is, for example, graphite, carbon black, acetylene black, ketjen black, or the like. However, the positive electrode conductive agent may be a metal material, a conductive polymer and the like as long as they are materials exhibiting conductivity.

Similarly, the negative electrode active material of the negative electrode material layer may be a material that contributes to occlusion and release of lithium ions. That is, the negative electrode layer may contain any one kind or two or more kinds among negative electrode materials capable of occluding and releasing lithium. From such a viewpoint, the negative electrode active material may be, for example, various carbon materials, metal-based materials, and/or other materials.

When a carbon material is used as the negative electrode active material, a change in the crystal structure at the time of occlusion of lithium and at the time of release of lithium is very small, so that a high energy density is easily obtained stably. In addition, since the carbon material also functions as a negative electrode conductive agent, the conductivity of the negative electrode layer is easily improved.

Specific examples of the carbon material include graphitizable carbon, non-graphitizable carbon, and/or graphite. More specifically, the carbon material may be, for example, pyrolytic carbons, cokes, glassy carbon fiber, organic polymer compound fired body, activated carbon, carbon blacks, or the like. The cokes may include pitch coke, needle coke, and petroleum coke. The organic polymer compound fired body is, for example, a material obtained by firing (carbonizing) a polymer compound such as phenol resin and furan resin at appropriate temperature. In addition, the carbon material may be low crystalline carbon subjected to a heat treatment at a temperature of about 1000° C. or less, or may be amorphous carbon. The shape of the carbon material is not particularly limited, and may be at least one of a fibrous shape, a spherical shape, a granular shape, and a scaly shape.

The “metal-based material” used as the negative electrode active material is a generic term for materials containing any one kind or two or more kinds among metal elements and metalloid elements as constituent elements. When a carbon material is used as the negative electrode active material, a high energy density is easily obtained. The metal-based material may be a simple substance, an alloy, a compound, two or more of these, or a material at least a part of which has phases formed of one or more of these. However, the alloy may include a material containing one or more kinds of metal elements and one or more kinds of metalloid elements in addition to a material formed of two or more kinds of metal elements. The alloy may also contain a non-metallic element. The construction of this metal-based material may be, for example, a solid solution, a eutectic (eutectic mixture), an intermetallic compound, and a material in which two or more kinds among these coexist. Such metal element and metalloid element may be, for example, any one kind or two or more kinds among metal elements and metalloid elements capable of forming an alloy with lithium. Specific examples of the metal element and the metalloid element may include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc, hafnium (Hf), zirconium, yttrium (Y), palladium (Pd), and/or platinum (Pt). In a preferred aspect, the metal element or metalloid element is silicon and tin. This is because the ability to store and release lithium is excellent and thus a higher energy density is obtained. A material containing silicon as a constituent element may be a simple substance of silicon, an alloy of silicon, or a compound of silicon, may be two or more thereof selected therefrom, or may include one or more phases thereof in part or all thereof. Similarly, a material containing tin as a constituent element may be a simple substance of tin, an alloy of tin, or a compound of tin, may be two or more thereof, or may include one or more phases thereof in part or all thereof. The “simple substance” described in the present specification is a simple substance in a general sense to the utmost, and thus the simple substance may contain a small amount of impurities. That is, the purity of the simple substance is not necessarily limited to 100%. The alloy of silicon may contain, for example, any one or two or more of tin, nickel, copper, iron, cobalt, manganese, zinc, indium, silver, titanium, germanium, bismuth, antimony, chromium, or the like as constituent elements other than silicon. The compound of silicon may contain, for example, any one or two or more of carbon, oxygen or the like as constituent elements other than silicon. The compound of silicon may contain, for example, any one or two or more of a series of elements described in the alloy of silicon as constituent elements other than silicon. As specific examples of the alloy of silicon and the compound of silicon, SiB₄, SiB₆, MgSi, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≤2), and/or LiSiO can be exemplified. In SiOᵥ, V may be 0.2<v<1.4. The alloy of tin may contain, for example, any one or two or more types of silicon, nickel, copper, iron, cobalt, manganese, zinc, indium, silver, titanium, germanium, bismuth, antimony, chromium, and the like, as constituent elements other than tin. The compound of tin may contain, for example, any one or two or more types of carbon, oxygen, and the like, as constituent elements other than tin. The compound of tin may contain any one or two or more of a series of elements described in the alloy of tin, for example, as constituent elements other than tin. As specific examples of the alloy of tin and the compound of tin, SnO_{w} (0<w≤2), SnSiO₃, LiSnO, and/or Mg₂Sn can be exemplified. Particularly, the material containing tin as a constituent element may be, for example, a material (tin-containing material) containing a second constituent element and a third constituent element together with tin which is a first constituent element. The second constituent element may be, for example, any one or two or more of cobalt, iron, magnesium, titanium, vanadium, chromium, manganese, nickel, copper, zinc, gallium, zirconium, niobium, molybdenum, silver, indium, cesium (Ce), hafnium (Hf), tantalum, tungsten, bismuth, silicon, or the like. The third constituent element may be, for example, any one or two or more of boron, carbon, aluminum, phosphorus, or the like. This is because a high battery capacity, excellent cycle characteristics and the like can be easily obtained. Among these, the tin-containing material may be a material (tin cobalt carbon-containing material) containing tin, cobalt, and carbon as constituent elements. This is because a high energy density can be obtained. In the tin cobalt carbon-containing material, at least a part of carbon which is a constituent element may be bonded to a metal element or metalloid element which is another constituent element. This is because the aggregation of tin, crystallization of tin, and the like can be easily suppressed. The tin cobalt carbon-containing material is not limited to the material (SnCoC) that contains only tin, cobalt, and carbon as constituent elements. This tin cobalt carbon-containing material may further contain, for example, any one or two or more of silicon, iron, nickel, chromium, indium, niobium, germanium, titanium, molybdenum, aluminum, phosphorus, gallium, bismuth or the like as a constituent element in addition to tin, cobalt, and carbon. In addition to the tin cobalt carbon-containing material, a material (tin cobalt iron carbon-containing material) containing tin, cobalt, iron, and carbon as constituent elements may be employed.

In addition to these, the negative electrode material may be any one kind or two or more kinds among, for example, metal oxides and polymer compounds. Examples of the metal oxide include iron oxide, ruthenium oxide, and molybdenum oxide. Examples of the polymer compound include polyacetylene, polyaniline, and polypyrrole.

The negative electrode material layer may contain a binder. Furthermore, a negative electrode conductive agent may be contained in the negative electrode material layer in order to facilitate transfer of electrons promoting the battery reaction. The binder which can be contained in the negative electrode material layer is not particularly limited, but examples thereof include at least one kind selected from the group consisting of styrene-butadiene rubber, polyacrylic acid, polyvinylidene fluoride, a polyimide-based resin, and a polyamideimide-based resin. The negative conductive agent that can be contained in the negative electrode material layer is not particularly limited, but examples thereof can include at least one selected from carbon blacks such as thermal black, furnace black, channel black, ketjen black, and acetylene black, carbon fibers such as graphite, carbon nanotube, and vapor-grown carbon fiber, metal powders such as copper, nickel, aluminum and silver, and polyphenylene derivatives. Note that the negative electrode material layer may contain a component derived from a thickener component (for example, a carboxymethyl cellulose) used at the time of manufacturing the battery.

The positive electrode current collector and the negative electrode current collector used for the positive electrode and the negative electrode are members that contribute to collecting and supplying electrons generated in the electrode active material due to the battery reaction. Such an electrode current collector may be a sheet-shaped metal member. The electrode current collector may be a single layer or a multilayer. In addition, the electrode current collector may have a porous or perforated form. For example, the current collector may be a metal foil, a punching metal, a net, an expanded metal, or the like. The positive electrode current collector that is used for the positive electrode may be made of, for example, a metal foil containing at least one selected from the group consisting of aluminum, nickel, stainless steel, and the like. On the other hand, the negative electrode current collector that is used for the negative electrode may be made of, for example, a metal foil containing at least one selected from the group consisting of copper, aluminum, nickel, stainless steel, and the like.

The separator used for the positive electrode and the negative electrode is a member provided from the viewpoints of the prevention of short circuit due to contact between the positive and negative electrodes and the holding of the electrolyte and the like. In other words, the separator is a member that separates the positive electrode and the negative electrode, and allows ions (for example, lithium ions) to pass while preventing a short circuit of a current due to contact between both electrodes. For example, the separator may be a porous or microporous insulating member, which may have a film form due to its small thickness.

This separator may be, for example, any one kind or two or more kinds among porous films of synthetic resins and/or ceramics and may be a stacked film of two or more kinds of porous films. The synthetic resin used for the separator is, for example, polytetrafluoroethylene, polypropylene, polyethylene, or the like. For example, the separator may include the porous film (substrate layer) and a polymer compound layer provided on one side or both sides of the base layer. This is because the close contact property of the separator with respect to the positive electrode is improved as well as the close contact property of the separator with respect to the negative electrode can be improved, and thus the distortion of the wound electrode body is likely to be suppressed. The polymer compound layer may contain, for example, any one or two or more types of polymer compounds such as polyvinylidene fluoride. It is excellent in physical strength and easily becomes electrochemically stable. It should be understood that the polymer compound layer may contain any one or two or more types of insulating particles such as an inorganic particle. The kind of inorganic particles may include aluminum oxide and/or aluminum nitride. In the present disclosure, the separator is not to be particularly limited by its name, and may be, for example, a solid electrolyte, a gel-like electrolyte, and/or an insulating inorganic particle having a similar function.

In the secondary battery of the present disclosure, the electrode assembly including the electrode-constituting layer including the positive electrode, the negative electrode, and the separator may be enclosed in the outer case together with an electrolyte. The electrolyte may be a so-called “non-aqueous” electrolyte.

The electrolyte may typically be an electrolytic solution. The electrolytic solution contains a solvent and an electrolyte salt. The electrolytic solution may further contain any one or two or more of other materials such as additives. In a preferred aspect, the separator may be impregnated with an electrolytic solution, and the positive electrode and/or the negative electrode may also be impregnated with an electrolytic solution.

The solvent may contain any one or two or more of non-aqueous solvents such as organic solvents. The electrolytic solution containing a nonaqueous solvent may be a so-called nonaqueous electrolytic solution. Examples of the non-aqueous solvent include a cyclic carbonate ester, a chain carbonate ester, a lactone, a chain carboxylate ester, and/or a nitrile (for example, mononitrile). This is because more excellent battery capacity, cycle characteristics and/or storage characteristics can be easily obtained. Examples of the cyclic carbonate ester may include ethylene carbonate, propylene carbonate, and/or butylene carbonate. The chain carbonate ester may be, for example, dimethyl carbonate, diethyl carbonate, ethyl methyl carbonate, and/or methyl propyl carbonate. The lactone may be, for example, γ-butyrolactone, and/or γ-valerolactone. The chain carboxylate ester may be methyl acetate, ethyl acetate, methyl propionate, ethyl propionate, methyl butyrate, methyl isobutyrate, methyl trimethylacetate, and/or ethyl trimethylacetate. The nitrile may be acetonitrile, methoxyacetonitrile, and/or 3-methoxypropionitrile. The non-aqueous solvent may be 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N,N-dimethylformamide, N-methylpyrrolidinone, N-methyloxazolidinone, N,N′-dimethylimidazolidinone, nitromethane, nitroethane, sulfolane, trimethyl phosphate, and/or dimethyl sulfoxide. Among them, the nonaqueous solvent preferably contains one or more of ethylene carbonate, propylene carbonate, dimethyl carbonate, diethyl carbonate, ethyl methyl carbonate and the like. This is because higher battery capacity, more excellent cycle characteristics, and/or more excellent storage characteristics are easily provided. In addition, the non-aqueous solvent may be an unsaturated cyclic carbonate ester, a halogenated carbonate ester, a sulfonate ester, an acid anhydride, a dicyano compound (dinitrile compound), a diisocyanate compound, a phosphate ester, and/or a chain compound having a carbon-carbon triple bond. This is because chemical stability of the electrolytic solution is easily improved. The “unsaturated cyclic carbonate ester” as used herein is a cyclic carbonate ester having one or more unsaturated bonds (carbon-carbon double bonds or carbon-carbon triple bonds). As this unsaturated cyclic carbonate ester, vinylene carbonate, vinyl ethylene carbonate, and/or methylene ethylene carbonate can be exemplified. The “halogenated carbonate ester” is a cyclic carbonate ester having one or more halogen elements as constituent elements or a chain carbonate ester having one or more halogen elements as constituent elements. In a case in which the halogenated carbonate ester contains two or more halogens as a constituent element, the kind of the two or more halogens may be one kind or two or more kinds. As the cyclic halogenated carbonate ester, for example, 4-fluoro-1, 3-dioxolan-2-one, and/or 4,5-difluoro-1,3-dioxolan-2-one can be exemplified. The chain halogenated carbonate ester may be, for example, fluoromethyl methyl carbonate, bis (fluoromethyl) carbonate, and/or difluoromethyl methyl carbonate. The sulfonate ester may be a monosulfonate ester and/or a disulfonate ester. The monosulfonate ester may be a cyclic monosulfonate ester or a chain monosulfonate ester. The cyclic monosulfonate ester may be sultones such as 1,3-propane sultone, and/or 1,3-propene sultone. Examples of the chain monosulfonate ester include a compound in which a cyclic monosulfonate ester is cleaved in the middle. The disulfonate ester may be a cyclic disulfonate ester or a chain disulfonate ester. The acid anhydride may be, for example, carboxylic acid anhydride, disulfonic acid anhydride, and/or carboxylic acid sulfonic acid anhydride. The carboxylic acid anhydride may be, for example, succinic anhydride, glutaric anhydride, and/or maleic anhydride. The disulfonic acid anhydride may be, for example, ethanedisulfonic anhydride, and/or propanedisulfonic anhydride. The carboxylic acid sulfonic acid anhydride may be, for example, sulfobenzoic anhydride, sulfopropionic anhydride, and/or sulfobutyric anhydride. A dinitrile compound is, for example, a compound represented by NC-R1-CN (R1 represents either of an alkylene group or an arylene group). The dinitrile compound may include succinonitrile (NC—C₂H₄—CN), glutaronitrile (NC—C₃H₆—CN), adiponitrile (NC—C₄H₈CN), and phthalonitrile (NC—C₆H₄—CN). A diisocyanate compound is, for example, a compound represented by OCN-R2-NCO (R2 represents either of an alkylene group or an arylene group). The diisocyanate compound may be hexamethylene diisocyanate (OCN—C₆H₁₂—NCO) or the like. The phosphate ester may be trimethyl phosphate and triethyl phosphate. A chain compound having a carbon-carbon triple bond is a chain compound having one or two or more carbon-carbon triple bonds (—C≡C—). This chain compound having a carbon-carbon triple bond may be propargyl methyl carbonate (CH≡C—CH₂—O—C(═O)—O—CH₃) and propargyl methanesulfonate (CH≡C—CH₂—O—S(═O)₂—CH₃).

For example, the electrolyte salt included in the electrolytic solution may be any one or two or more of salts such as a lithium salt. The electrolyte salt may contain a salt other than a lithium salt, for example. The salt other than lithium may be, for example, salts of light metals other than lithium. Examples of the lithium salts include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and/or lithium bromide (LiBr). This is because more excellent battery capacity, cycle characteristics and/or storage characteristics can be easily obtained. Among these, any one kind or two or more kinds among lithium hexafluorophosphate, lithium tetrafluoroborate, lithium perchlorate, and lithium hexafluoroarsenate may be employed.

A battery can used in a secondary battery corresponds to a member enclosing an electrode assembly in which electrode-constituting layers including a positive electrode, a negative electrode, and a separator are stacked as a battery package. The battery can may have, for example, a hollow structure in which one end portion is closed and the other end portion is opened (opened as an open end portion). The battery can is not particularly limited, but may be a metal can containing any one of, or two or more of metal materials such as iron, aluminum, stainless steel, and alloys thereof. One or more of metal materials such as nickel may be plated on the surface of the battery can, for example. A safety valve may be provided at the opening end of the battery can. Although it is merely an example, a safety valve may be provided at the opening end of the battery can together with a thermal resistor or the like with a gasket interposed therebetween (that is, the battery safety valve may be provided together with a caulking mechanism).

The battery of the present disclosure has features related to its safety mechanism. In particular, it has a feature related to a safety valve provided on a battery can (particularly, an opening end thereof) of a battery.

The safety valve provided in the battery of the present disclosure includes at least a first metal member, a second metal member, and an insulating member positioned therebetween. The first metal member is positioned relatively outside in the battery axial direction, while the second metal member is positioned relatively inside in the battery axial direction, and they are electrically connected to each other. Preferably, the first metal member and the second metal member are connected to each other across the insulating member. Each of the first metal member and the second metal member may be a disk-shaped or plate-shaped member (that is, it may have a form extending on the same plane as a whole). The insulating member preferably has an opening part or a hollow portion in an inner or central region thereof, and may have a plate shape (for example, a flat plate shape) or a flat shape as a whole, as will be described later. In the present disclosure, the first metal member, the second metal member, and the insulating member are preferably disposed so as to be directly stacked on each other, and constitute a thin safety valve.

Further, in the safety valve according to the present disclosure, a stepped part is provided in the first metal member. Specifically, in the safety valve according to the present disclosure, the first metal member has a stepped part including a thin portion having a thickness relatively reduced as compared with other portions.

The first metal member is displaced by receiving the battery internal pressure at the time of abnormality, thereby contributing to the function of the safety valve. More specifically, when the second metal member is broken starting from the groove, the first metal member bends together with the broken second metal member, and the current interruption is performed through such displacement. In the present disclosure, the specific stepped part of the first metal member contributes to improvement of the interruption reliability in the action of the safety valve.

In the present disclosure, when achieving the current interruption at the time of abnormality such as an increase in can internal pressure, the “stepped part including a thin portion having a thickness relatively reduced as compared with other portions” can reduce or avoid an inconvenient displacement such as a spring back phenomenon of the first metal member after the safety valve is cleaved. As a result, unintended current conduction after breakage of the second metal member that contributes to the current interruption can be avoided, and a more reliable battery can be obtained. In addition, when the reliability is increased as described herein, the predictability as the behavior at the time of abnormal increase in the internal pressure is improved, and a battery having a higher degree of freedom in design is easily realized.

Hereinafter, such a battery of the present disclosure will be described in further detail with appropriate reference to the drawings according to an embodiment. A configuration of a safety valve of a battery according to the present disclosure includes at least a first metal member, a second metal member, and an insulating member positioned therebetween. As one specific exemplary embodiment, an aspect in which the first metal member corresponds to a safety cover and the second metal member corresponds to a stripper disk will be described below as an example.

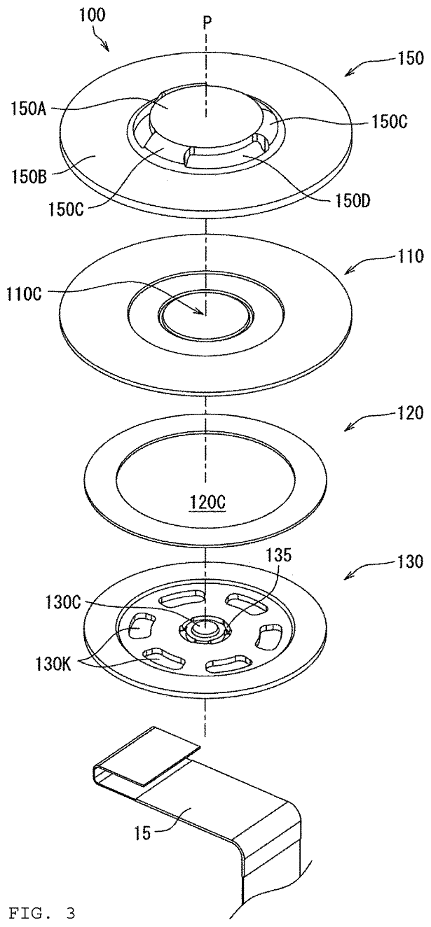

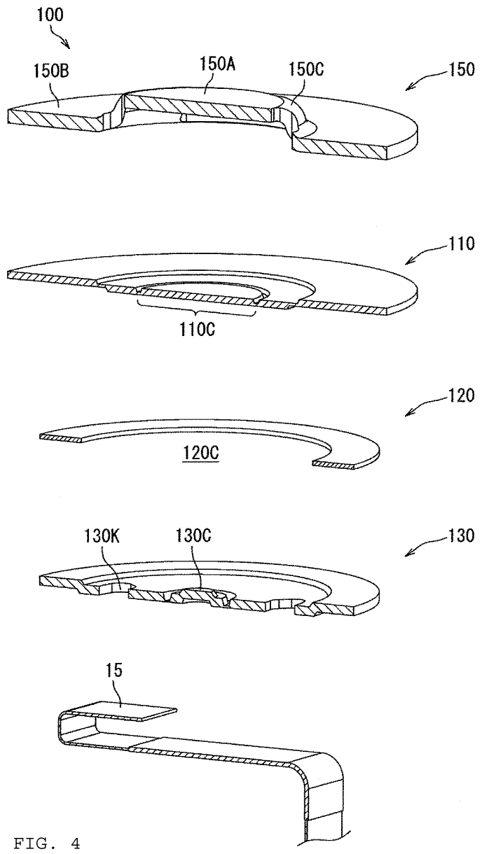

FIGS. 1 and 2 schematically illustrate an appearance of a secondary battery according to an embodiment of the present disclosure and a sectional view thereof. As illustrated, the secondary battery 1000 of the present disclosure may be a cylindrical secondary battery (for example, a cylindrical non-aqueous secondary battery). In other words, the secondary battery of the present disclosure may include a cylindrical case, that is, a cylindrical battery can 50. The safety valve 100 may be provided at a cylindrical end portion of the secondary battery 1000 (particularly, an opening end side of the battery can). FIG. 3 illustrates the safety valve 100 in a developed state together with its related members (or peripheral members), and FIG. 4 illustrates each constituent member of the safety valve 100 as a half perspective view.

As illustrated in FIGS. 3 and 4, the safety valve 100 has a configuration in which a safety cover 110 provided as a first metal member, an insulating member 120, and a stripper disk 130 provided as a second metal member are combined with each other in this order along a battery axis P. When viewed along the axial direction of the cylindrical shape of the battery, the safety cover 110 of the first metal member is positioned relatively outside the battery (that is, for example, the side farther from the electrode assembly such as the wound structure), while the stripper disk 130 of the second metal member is positioned relatively inside the battery (that is, for example, a side closer to an electrode assembly such as a wound structure), and the insulating member 120 is interposed between the safety cover 110 and the stripper disk 130. In the present specification, the “battery axis” refers to an axis P extending in a direction perpendicular to an end surface (particularly, a virtual planar end surface) of the battery can so as to pass through the center of the battery can corresponding to the battery package (refer to FIGS. 1 and 2). For example, it can also be said that the battery axis refers to an axis that passes through the center of an exterior body 50 and extends in a direction orthogonal to the extending direction of the safety valve 100. Therefore, an expression such as “battery axial direction” described herein or below refers to a direction along the battery axis.

Each member constituting the safety valve 100 will be described in detail. The safety valve 100 contributes to a battery terminal (that is, one of the positive electrode terminal and the negative electrode terminal as the external terminal of the battery) and has, as a battery safety mechanism, a mechanism that can be displaced according to an excessive the battery internal pressure. Therefore, the safety valve 100 includes the safety cover 110 and the stripper disk 130 that can be displaced according to the excessive battery internal pressure, and at least includes the insulating member 120 therebetween as a component. Such a safety valve 100 may be provided at one end portion of the battery can, and is provided at an opening end 51 in the battery can 50 of FIGS. 1 and 2. In the safety valve 100, a top cover 150 may be further provided outside in the battery axial direction with respect to the safety cover 110 provided as the first metal member (refer to FIGS. 3 and 4).

The safety cover 110 provided as the first metal member mainly corresponds to a displaceable member that can close the opening end 51 of the battery can 50 and can be displaceable and/or openable in response to an increase in the internal pressure of the battery can. The internal pressure of the battery can increases due to a side reaction such as a decomposition reaction of the electrolytic solution, for example. That is, since a gas such as carbon dioxide is generated inside the battery can when a side reaction such as a decomposition reaction of the electrolytic solution occurs, the internal pressure of the battery can undesirably increases according to an increase of the generation amount of the gas.

The safety cover 110 may be a metal member. For example, the safety cover 110 may include any one of, or two or more of metal materials such as iron (Fe), aluminum (for example, aluminum metal or aluminum alloy, such as A1050, A3203, and/or A5052), titanium (Ti), platinum (Pt), and gold (Au). In other words, it can be said that the safety cover 110 may be a member made of such a conductive material. A planar shape of the safety cover 110, particularly an outer ring contour shape in a plan view (hereinafter, also referred to as an “outer contour shape in a plan view”) is not particularly limited, but may be, for example, a circular shape, a polygonal shape, or another shape. The circular shape is, for example, a true circle (perfect circle), an ellipse, a substantial circle, or the like. The substantial circle is, for example, a generic name of a some or all distorted shape of a true circle. The polygons are, for example, triangles, squares, pentagons and hexagons. The other shapes are, for example, shapes other than a circle whose contour is formed only by a curve, shapes in which two or more types of polygons are combined, and shapes in which one or more types of circles and one or more types of polygons are combined. Such a definition of “circular” and the like is the same hereinafter. In the illustrated exemplary embodiment, the outer contour shape of the safety cover 110 in a plan view is circular.

The safety cover 110 may have, for example, a flat plate shape as a whole. That is, the safety cover 110 may have a form extending on the same plane as a whole. Although it is merely an example, the thickness of the safety cover 110 may be substantially constant except for a stepped part, a groove (for example, a groove that contributes to displacement, deformation, breakage, cleavage, and the like of the safety cover), and the like provided in the safety cover. The safety cover 110 having such a form extending on the same plane as a whole contributes to thinning of the battery safety valve.

The insulating member 120 is interposed between the safety cover 110 and the stripper disk 130, and corresponds to a member that enables at least the safety cover 110 and the stripper disk 130 to be connected to each other. The insulating member 120 may have an annular shape as a whole. That is, the shape of the insulating member 120 in a plan view may be a loop shape, a ring shape, or the like. Due to such a loop shape or ring shape, the inner region of the insulating member 120 forms a hollow portion or an opening region 120C (that is, “cavity” described later). An outer contour shape of such an insulating member 120 in a plan view is not particularly limited, but may be the same as the outer contour shape of the safety cover 110 in a plan view, and may be, for example, a circular shape. The loop shape or ring shape of the insulating member 120 may be provided as the whole member (refer to FIG. 3), or the loop shape or ring shape may be locally divided. Further, the insulating member 120 may have, for example, a flat plate shape as a whole. That is, the insulating member 120 may have a form extending on the same plane as a whole. Such an insulating member 120 extending on the same plane contributes to a reduction in thickness of the battery safety valve. Although it is merely an example, the insulating member 120 may have a substantially constant thickness between the safety cover 110 and the stripper disk 130. Preferably, the insulating member 120 may be interposed between the safety cover 110 and the stripper disk 130 such that the opening region 120C of the insulating member 120 is positioned in the region including the battery axis.

Since the insulating member 120 has an insulating property, electrical conduction via the insulating member 120 is preferably prevented. The term “insulation” as used herein may have an electrical resistivity, that is, the insulation property of a general insulator, and therefore may have an electrical resistivity of the general insulator, and may have a resistivity of at least 1.0×10⁵ Ω·m or more, preferably 1.0×10⁶ Ω·m or more, and more preferably 1.0×10⁷ Ω·m or more (room temperature: 20° C.) although it is merely an example.

In a preferred aspect, the insulating member 120 interposed between the safety cover 110 and the stripper disk 130 may contribute to insulation, and may not necessarily be bonded thereto. On the other hand, for example, when bonded, the insulating member 120 may be interposed between the safety cover 110 and the stripper disk 130 as an adhesive layer. Note that the insulating member 120 may be interposed between the safety cover 110 and the stripper disk 130 such that the opening region 120C of the insulating member 120 is positioned in the region including the battery axis.

The insulating member 120 is preferably made of a resin material. That is, the main component of the insulating member may be a resin material, or the insulating member may be configured to include at least a resin in the material of the member. When formed of a resin material as described herein, the insulating member 120 more suitably contributes to the adhesiveness between the safety cover 110 and the stripper disk 130 while securing the insulating property, and furthermore, the insulating member 120 suitably contributes to the realization of a thinner safety valve. When the insulating member 120 is made of a resin material, for example, the insulating member 120 may be made of a thermosetting resin, a thermoplastic resin, and/or a UV curable resin. In a case where a viewpoint of connectivity is particularly emphasized, the insulating member 120 may be a member including a resin adhesive having insulating properties. Examples of such a resin adhesive include an acrylic-based resin adhesive such as acrylic acid ester copolymers, a rubber-based resin adhesive such as natural rubber, a silicone-based resin adhesive such as silicone rubber, a urethane-based resin adhesive such as a urethane resin, an α-olefin-based resin adhesive, an ether-based resin adhesive, an ethylene-vinyl acetate resin-based resin adhesive, an epoxy resin-based resin adhesive, a vinyl chloride resin-based resin adhesive, a chloroprene rubber-based resin adhesive, a cyanoacrylate-based resin adhesive, an aqueous polymer-isocyanate-based resin adhesive, a styrene-butadiene rubber-based resin adhesive, a nitrile rubber-based resin adhesive, a nitrocellulose-based resin adhesive, a reactive hot-melt-based resin adhesive, a phenol resin-based resin adhesive, a modified silicone-based resin adhesive, a polyamide resin-based resin adhesive, a polyimide-based resin adhesive, a polyurethane resin-based resin adhesive, a polyolefin resin-based resin adhesive, a polyvinyl acetate resin-based resin adhesive, a polystyrene resin solvent-based resin adhesive, a polyvinyl alcohol-based resin adhesive, a polyvinyl pyrrolidone resin-based resin adhesive, a polyvinyl butyral resin-based resin adhesive, a polybenzimidazole-based resin adhesive, a polymethacrylate resin-based resin adhesive, a melamine resin-based resin adhesive, a urea resin-based resin adhesive, and/or a resorcinol-based resin adhesive.

The insulating member 120 has a cavity 120C at a position corresponding to a central portion 110C of the safety cover 110 (refer to FIGS. 3 and 4). The cavity 120C corresponds to an inner opening region or a hollow region of the insulating member that provides the insulating member 120 with an annular shape (loop shape or ring shape). The cavity 120C of the insulating member 120 may be provided in a region including the battery axis. The opening shape of the cavity 120C of the insulating member 120 (particularly, in a plan view, the planar opening shape) is not particularly limited, and may be, for example, the same as the outer contour shape of the safety cover 110 in a plan view. In the illustrated exemplary embodiment, the opening shape of the cavity 120C of the insulating member 120 is circular.

The stripper disk 130 provided as the second metal member is disposed relatively inside the battery with respect to the safety cover 110 with the insulating member 120 interposed therebetween, and corresponds to a member that contributes to current interruption at the time of abnormality and/or, for example, passage or release of gas inside the battery can.

The stripper disk 130 may be a metal member. For example, the stripper disk 130 may include any one of, or two or more of metal materials such as iron (Fe), aluminum (for example, aluminum metal or aluminum alloy, such as A1050, A3203, and/or A5052), titanium (Ti), platinum (Pt), and gold (Au). In other words, the stripper disk 130 may be a member made of such a conductive material. The material of the stripper disk 130 may be the same as or different 110 from the material of the safety cover 110. The contour shape of the stripper disk 130 in a plan view is not particularly limited, but is, for example, similar to the outer contour shape of the safety cover 110 in a plan view. In the illustrated exemplary embodiment, the outer contour shape of the stripper disk 130 in a plan view is circular.

The stripper disk 130 may have, for example, a flat plate shape as a whole. That is, the stripper disk 130 may have a form of extending on the same plane. Such a stripper disk extending on the same plane as a whole contributes to thinning of the battery safety valve. For example, the stripper disk 130 may have a substantially constant thickness as a whole except for a central region or the like. A central region 130C of the stripper disk 130 may be relatively raised (preferably raised outward along the battery axis) with respect to a region other than the region to contribute to connection with the safety cover 110. In other words, although the stripper disk 130 has a plate shape as a whole, at least the central portion of the region including the battery axis may be relatively protruded.

The stripper disk 130 may be provided with a plurality of cavities 130K. The plurality of cavities 130K mainly correspond to ventilation ports that contribute to passage or release of gas inside the battery can. For example, the plurality of cavities 130K may be provided in a region on the outer peripheral side of the central region 130C.

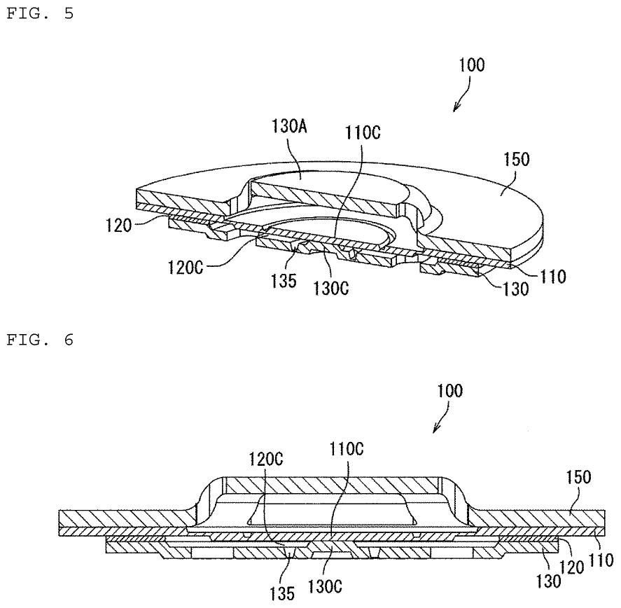

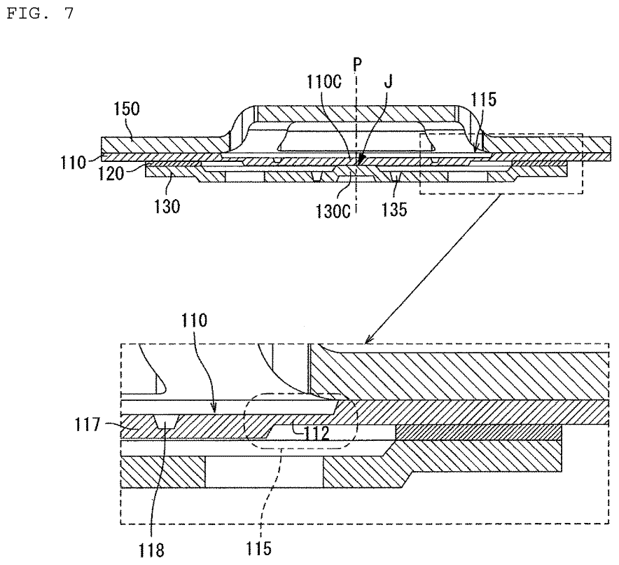

In the safety valve, the safety cover 110 and the stripper disk 130 are integrated as a whole by interposing the insulating member 120 therebetween, but the safety cover 110 and the stripper disk 130 may be electrically connected to each other in a central region thereof. For example, the safety cover 110 may be directly connected to the central region 130C of the stripper disk 130 so as to straddle the insulating member 120. More specifically, as illustrated in FIGS. 5 and 6, the central region 110C of the safety cover 110 and the central region 130C of the stripper disk 130 may be directly connected to each other through the cavity 120C of the insulating member 120.

As described herein, the safety valve may further include the top cover 150. That is, the top cover 150 may be further provided relatively outside the safety cover 110 provided as the first metal member in the battery axial direction. In the safety valve, the top cover 150 is preferably electrically connected to the safety cover 110. The top cover corresponds to a battery cover provided to cover the opening end of the battery can together with other components of the safety valve. In other words, the safety cover 110 is connected to the top cover 150 forming an external terminal of the battery. As illustrated in FIGS. 3, 4, and the like, the top cover 150 has a protrusion 150A that protrudes outward in the battery axial direction. In particular, the protrusion 150A is provided in the central region of the top cover. The protrusion 150A of the top cover 150 has a shape protruding to the outside of the battery, and the top cover 150 includes at least one bent portion 150C extending from a flat plate portion 150B toward the outside of the battery, and the bent portions 150C are separated from each other (refer to FIG. 3). A cavity 150D is provided in the top cover 150 due to the separation of the bent portion. Such a top cover 150 can suitably function as a terminal of the battery. For example, the top cover 150 functions as a positive electrode terminal of the battery, and the battery can functions as a negative electrode terminal. In such a case, the top cover and the battery can may be insulated from each other. For example, the top cover may be insulated from the battery can by interposing an insulating material between the top cover and the battery can. Although it is merely an example, a safety valve including a top cover may be provided on the battery can with an insulating material interposed between the top cover and the battery can having a narrowed or constricted portion in some parts. Further, as another example, the top cover and the battery can may be insulated from each other by interposing a holder member (particularly, an insulating holder member/not shown) provided so as to support the first metal member at a peripheral edge of the safety cover provided as the first metal member (in such a case, the battery can may not be the “battery can having a narrowed or constricted portion in some parts” described herein, and thus may be a non-narrowed or non-constricted battery can). The cavity 150D of the top cover 150 can act as a discharge hole for discharging a gas generated inside the battery to the outside of the battery. The material of the top cover 150 may be metal. For example, the top cover 150 may be made of a conductive material such as steel such as iron (Fe) and SPCC, stainless steel (SUS) such as SUS430 and SUS304, nickel (Ni), aluminum (Al), and/or titanium (Ti).

A conductive member 15 extending from the electrode assembly 10 is connected to the safety valve. The conductive member 15 is electrically connected to the electrode assembly 10 (in particular, one of the positive electrode and the negative electrode), and contributes to electrical connection between the electrode assembly 10 and the safety valve (in particular, the stripper disk 130). More preferably, the conductive member 15 may be connected to a region outside the central region 130C of the stripper disk 130 corresponding to the second metal member, preferably a region (that is, a region positioned on a side farther from the cleavage groove with respect to the battery axis) on the outer peripheral side of the groove (particularly cleavage groove). In the safety valve, the stripper disk 130 is electrically connected to the safety cover 110 with the central region 130C interposed therebetween, and the safety cover 110 is connected to the top cover 150 forming an external terminal of the battery. Therefore, the electrode assembly 10 such as the wound structure is electrically connected to the battery external terminal with the conductive member 15 interposed therebetween. In the present specification, the conductive member 15 may be a member containing metal, and preferably may be a metal member having an elongated shape. For example, the conductive member may include an electrode current collector of the electrode assembly, or may be a current collecting lead (that is, the lead) provided in the electrode assembly (in particular, the electrode). When the conductive member is made of the electrode current collector, the conductive member may be made of a metal portion of the electrode current collector where the electrode material is not provided. When the conductive member is formed of a current collecting lead, the conductive member may be formed of a metal member having a thin form and/or a long form. In the present disclosure, the conductive member electrically connecting the electrode assembly and the electrode terminal to each other can also be referred to as a “tab”. The conductive member used for such a secondary battery preferably has flexibility, and may be provided in a bent form and/or a bent form.

In the safety valve according to the secondary battery of the present disclosure, the safety cover 110 provided as the first metal member, the insulating member 120, and the stripper disk 130 provided as the second metal member are combined so as to be stacked on each other. More specifically, as illustrated in FIGS. 5 and 6, the safety cover 110 provided as the first metal member and the insulating member 120 are disposed so as to be stacked on each other, the insulating member 120 and the stripper disk 130 provided as the second metal member are disposed so as to be stacked on each other, and the top cover 150 is disposed so as to be stacked on the safety cover 110 provided as the first metal member. In such a combination of safety valves, the stripper disk 130 provided as the second metal member is provided with a groove that contributes to current interruption at the time of abnormality, that is, an interruption groove.

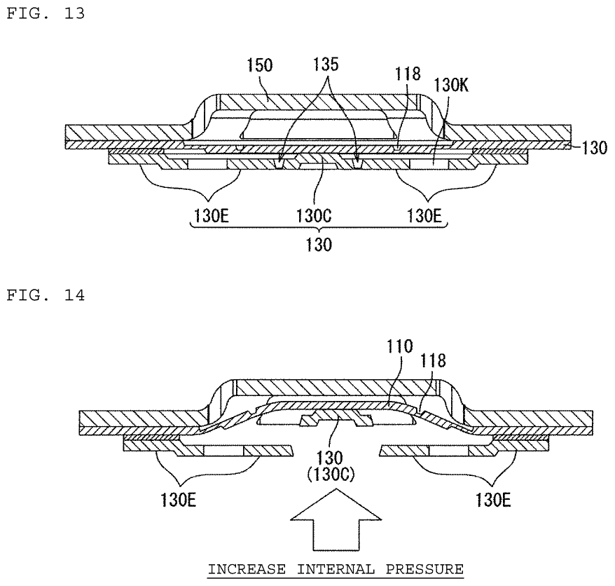

When the internal pressure of the battery can abnormally increases, the stripper disk 130 can be broken starting from the interruption groove, and the following inconvenient current can be interrupted. The groove 135 provided in the stripper disk 130 of the second metal member may be a groove having an opening toward the outside thereof when viewed along the battery axis (that is, the groove may be a groove opened on a surface of the member surface of the second metal member on a side relatively proximal to the first metal member side). It is assumed that the pressure inside the battery can increases due to side reactions such as a decomposition reaction of the electrolytic solution or other factors. FIG. 13 illustrates a state in which the internal pressure of the battery, that is, the internal pressure of the battery can is in a normal range, and the battery safety valve is not particularly operated. As illustrated in the drawing, the stripper disk 130 and the safety cover 110 have not yet been displaced. When a gas is generated due to a side reaction such as a decomposition reaction of the electrolytic solution inside the battery can, the gas is accumulated in the battery can, so that the internal pressure of the battery can increases. When the internal pressure of the battery can continues to increase, the safety cover 110 is affected by the increase in the internal pressure. This is because the safety cover 110 and the inside of the battery can 50 are in fluid communication with each other while the stripper disk 130 is provided with the plurality of cavities 130K (refer to FIGS. 3 and 4). When the internal pressure of the battery can exceeds a certain predetermined pressure, the stripper disk 130 is pulled by the safety cover 110, and the stripper disk 130 is broken starting from the groove 135 (refer to FIGS. 13 and 14). This is because the stripper disk 130 and the safety cover 110 are connected to each other in the central region thereof, and particularly the central region 130C of the stripper disk 130 is pulled outward in the battery axial direction due to the force received from the safety cover 110 that tries to be displaced by receiving the internal pressure. That is, when the tensile force acting on the central region 130C exceeds a certain limit, the stripper disk 130 is broken starting from the groove 135 positioned around the central region. As can be seen from the configuration illustrated in FIGS. 13 and 14, when such breakage of the stripper disk 130 occurs, the safety cover 110 is electrically separated from a non-central region 130E (in particular, a non-central region 130E of a peripheral edge portion to which conductive members, such as tabs and leads, extending from the electrode assembly are still connected) of the stripper disk 130. Therefore, the electrical connection between the top cover 150 and the electrode assembly is disconnected, and the path of the current flowing between the electrode assembly and the top cover 150 is interrupted. In this manner, the current interruption can be achieved at the time of abnormality such as an increase in internal pressure. When the displacement of the safety cover 110 further progresses and the safety cover itself is cleaved, for example, broken or divided, the internal pressure of the battery can is more effectively reduced. For example, when a groove or the like is provided in the safety cover 110 corresponding to the first metal member (for example, in a case where a break groove or a cleavage groove such as a groove 118 to be described later is provided), the safety cover is broken/cleaved starting from the groove. In such a case, the gas release path through the plurality of cavities 130K of the stripper disk 130 is particularly opened, and the gas can be released to the outside of the battery through the cavities 130K.

When the safety valve is operated, the stripper disk 130 is broken as described herein, but the inventor of the present application has found that there is a case where current conduction is observed thereafter despite such breakage. In particular, it has been found that the safety cover may be displaced so as to be deflected along with the movement of the broken stripper disk to the outside (the outside along the battery axis), but the displacement is not finally desired, and unintended current conduction may occur after the breakage of the stripper disk. More specifically, the inventor of the present application has found that a spring back phenomenon or the like occurs with respect to displacement of the safety cover (for example, the spring-back of the safety cover is likely to occur when the can internal pressure is reduced by the cleavage of the safety valve), and undesired current conduction may be caused after breakage of the stripper disk due to the spring back phenomenon or the like.

On the other hand, the inventors of the present application have made studies, for example, to a battery capable of reducing or avoiding the above-described undesirable displacement during the operation of the safety valve. For example, it has been found that by providing the “stepped part 115 including a thin portion having a thickness relatively reduced as compared with other portions” in the safety cover 110, it is possible to more suitably reduce or avoid an inconvenient displacement (more specifically, an unfavorable displacement after the safety valve is cleaved, such as spring back, and the like) of the safety cover after the stripper disk breakage contributing to the current interruption. That is, by providing such a specific stepped part, a more reliable battery capable of reducing or avoiding undesired conduction during operation of the safety valve is provided.

In the following, such a specific stepped part will be described in more detail with reference to the drawings. FIG. 7 illustrates a sectional view of the safety cover 110 together with a peripheral member thereof. As illustrated in the drawing, in the sectional view, the safety cover 110 has a stepped part 115, and particularly has a “stepped part 115 including a thin portion having a thickness relatively reduced as compared with other portions”. That is, it can be said that there is a “stepped part 115 configured together with a thin form having a relatively reduced thickness”. As described herein, the present disclosure is at least characterized by having the stepped part 115 with a reduced thickness in the safety cover 110 corresponding to the first metal member.

In the present specification, the term “sectional view” related to the expression “sectional view of the safety valve” or the like is based on a cross section that can be obtained by cutting the safety valve in a plane along the battery axis. It is based on a cross section obtained by cutting each member constituting the safety valve along the thickness direction thereof, for example, when a safety cover or the like is cut along the thickness direction thereof.

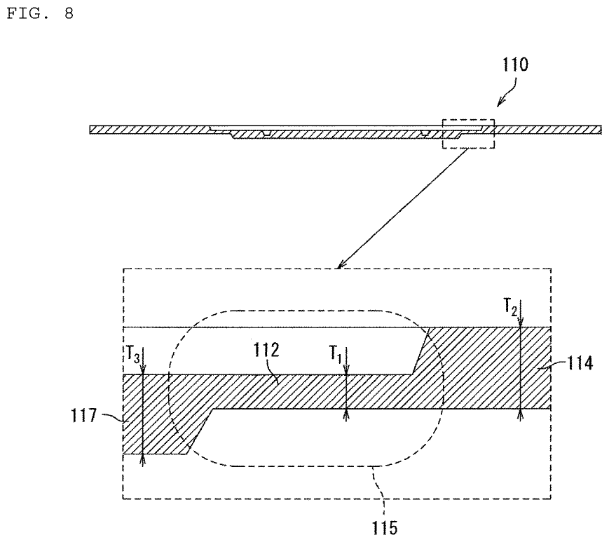

As illustrated in the sectional view of FIG. 8, the safety cover 110 corresponding to the first metal member has a stepped part 115 including a thin portion having a thickness relatively reduced as compared with other portions in the sectional view. That is, the safety cover 110 has the stepped part 115 configured together with a thin form having a relatively reduced thickness. In the safety cover 110, a thin portion, that is, a thin portion having a relatively reduced thickness is a portion denoted by reference numeral 112, and the stepped part 115 is included together with the thin portion.

The safety cover 110 is provided so as to extend generally on the same plane with the thin portion 112 as a reference, for example, and the stepped part 115 is provided in the safety cover 110 extending on such a same plane. The stepped part may be provided, for example, in a circumferential shape in the first metal member. That is, in a plan view of the first metal member (for example, the safety cover), the “stepped part 115 including a thin portion having a thickness relatively reduced as compared with other portions” may be continuously or intermittently provided so as to form an annular contour. At least due to the installation of such stepped parts, undesirable displacement during operation of the safety valve may be reduced or avoided. More specifically, it is possible to reduce or avoid the spring back (more preferably, the spring back after breakage/cleavage of the first metal member that particularly contributes to reduction of the can internal pressure) of the safety cover corresponding to the first metal member after breakage of the stripper disk corresponding to the second metal member, and finally, it is possible to suitably reduce or avoid undesired conduction during operation of the safety valve.

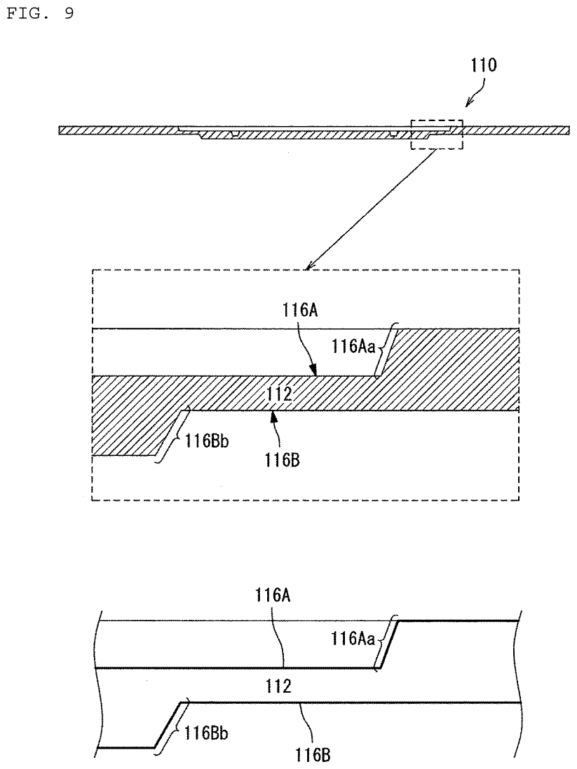

In a preferred aspect, in a sectional view of the safety valve, the stepped part is provided such that the outer contour of the first metal member has a stepped contour and the inner contour of the first metal member also has a stepped contour. More specifically, in the sectional view of the safety valve, the stepped part is provided such that the outer contour of the first metal member positioned relatively outside in the battery axial direction has a stepped contour, and the inner contour of the first metal member positioned relatively inside in the battery axial direction also has a stepped contour. In the aspect illustrated in FIG. 9, in the safety cover 110 corresponding to the first metal member, the outer contour is a contour 116A positioned relatively outside in the battery axial direction, and the inner contour is a contour 116B positioned relatively inside in the battery axial direction. The outer contour 116A has a stepped contour 116Aa in a part thereof, and the inner contour 116B also has a stepped contour 116Bb in a part thereof. Due to such a contour form, inconvenient displacement such as spring back of the safety cover corresponding to the first metal member at the time of operating the safety valve can be suitably reduced or easily avoided. That is, undesired conduction during operation of the safety valve is easily reduced or avoided. As illustrated in the sectional view of FIG. 9, the outer stepped contour 116Aa and the inner stepped contour 116Bb constituting the stepped part may have a point-symmetrical contour relationship with each other.

The thin portion 112 directly or indirectly involved in the specific step of the first metal member is preferably in a predetermined thickness range. More specifically, the thickness dimension of the thin portion 112 has a thickness ratio of 0.7 or less with respect to a non-thin thickness dimension corresponding to the thickness dimension of the other portion. That is, in the first metal member, the thickness dimension of the thin portion 112 provided by the thin form preferably has a thickness ratio of 0.7 or less with respect to the non-thin thickness dimension of the portion not having the thin form. The lower limit value of such a thin thickness dimension is not particularly limited, but may be, for example, 0.3, 0.4, 0.5, or the like with respect to the non-thin thickness dimension. In the aspect illustrated in FIG. 8, in the safety cover 110 corresponding to the first metal member, when the thickness dimension of the thin portion 112 is Ti and the thickness dimension of the non-thin site 114 of the other portion is T₂, T₁≤0.7T₂ may be satisfied. For example, 0.3T₂≤T₁≤0.7T₂, 0.4T₂≤T₁≤0.7T₂, 0.5T₂≤T₁≤0.7T₂, and the like may be satisfied. When the thickness ratio between the thin portion of the first metal member and the other portion (non-thin site) has such a relationship, displacement such as inconvenient spring back of the safety cover corresponding to the first metal member during operation of the safety valve is suitably reduced or easily avoided. That is, undesired conduction during operation of the safety valve is easily reduced or avoided.

As described herein, the “non-thin site” corresponding to the “other portion” may be regarded as corresponding to the safety cover portion positioned on the outer peripheral side of the thin portion (thin site) 112, but may be regarded as the safety cover portion positioned on the inner peripheral side of the thin portion 112. That is, when a thickness dimension of a non-thin site 117 in the other portion positioned on the inner peripheral side of the thin portion 112 is T₃ (refer to FIG. 8), T₁≤0.7T₃ may be satisfied. For example, 0.3T₃≤T₁≤0.7T₃, 0.4T₃≤T₁≤0.7T₃, 0.5T₃≤T₁≤0.7T₃, and the like may be satisfied. In the safety cover, the non-thin site 114 positioned on the outer peripheral side of the thin portion 112 and the non-thin site 117 positioned on the inner peripheral side of the thin portion 112 may have substantially the same thickness as other portions.

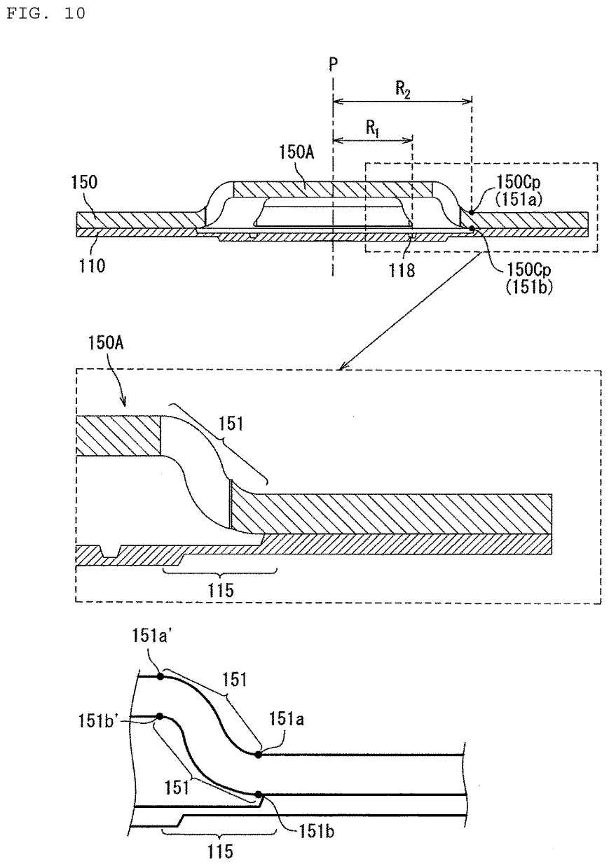

In a preferred aspect, the battery includes a top cover provided further outside than the first metal member, the top cover having such a protrusion protruding outward, and the stepped part of the first metal member and a protruding region of the protrusion of the top cover have a positional relationship in which the stepped part and the protruding region at least overlap each other in some parts. That is, when the battery further includes a top cover that is provided on the outer side in the battery axial direction relative to the first metal member and includes a protrusion that protrudes outward in the battery axial direction, the stepped part may be suitably provided on the first metal member in consideration of the balance with the top cover. Specifically, the stepped part of the first metal member may be positioned so as to extend over the region of the protrusion of the top cover (in other words, the stepped part of the first metal member may be provided at a position reaching the internal region of the protrusion of the top cover in a battery transverse direction orthogonal to the battery axial direction). Preferably, the stepped part of the first metal member and the protruding region of the protrusion of the top cover may have a positional relationship in which they at least overlap each other in some parts in the battery axial direction. In the aspect illustrated in FIG. 10, the stepped part 115 in the safety cover 110 corresponding to the first metal member at least overlaps in some parts with a protruding region 151 that can correspond to a side part of the protrusion 150A of the top cover 150. Due to such an overlap relationship in the safety valve, inconvenient displacement such as spring back of the safety cover corresponding to the first metal member at the time of operating the safety valve can be suitably reduced or easily avoided. In this aspect, as the displacement of the first metal member, large deformation that rises or bends from the vicinity of the periphery of the protrusion of the top cover is likely to occur. Due to such specific displacement, undesired conduction during operation of the safety valve is more suitably suppressed or easily avoided. The stepped part according to the invention of the present application contributes to reduction or avoidance of inconvenient displacement such as spring back, but since the stepped part has a thin form in despite of the above-described overlap relationship, it is easy to suitably avoid contact of the first metal member, which is deformed during operation of the safety valve, with the top cover (in particular, protruding region), and it is possible to suppress or avoid inconvenient fluctuation in the interruption/cleaving pressure and the like. Note that, regarding the overlap relationship, the “protruding region” may be regarded as a region (in the sectional view of FIG. 10, in the battery transverse direction orthogonal to the battery axial direction, a part between an outer boundary 151a and an inner boundary 151a′ or a part between an outer boundary 151b and an inner boundary 151b′) provided by a boundary between a straight part and a curved part in the sectional view contour from the outer edge part of the top cover to the protrusion, and the “stepped part” may be regarded as the thin portion 112. In the present disclosure, such specific portions may overlap each other in the battery axial direction.

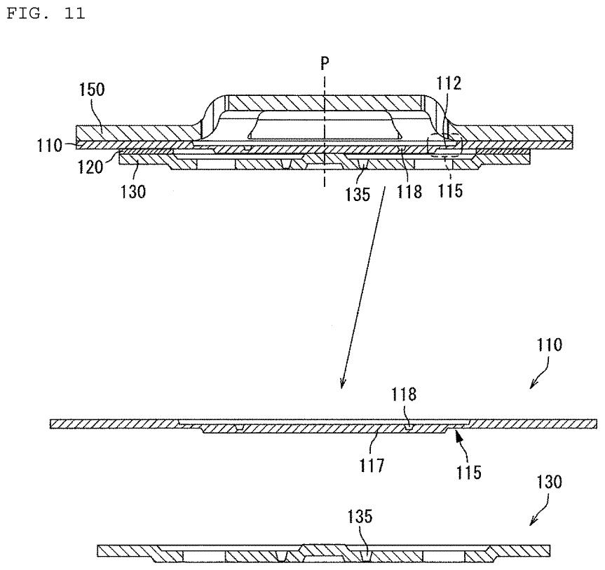

The first metal member may be provided with a groove on the inner peripheral side of the stepped part in addition to the stepped part. That is, the first metal member may further include a groove positioned relatively closer to the battery axis side than a “stepped part including a thin portion having a thickness relatively reduced as compared with other portions” (that is, “a stepped part configured together with a thin form having a relatively reduced thickness”). Referring to FIGS. 7 and 11, in the safety cover 110 corresponding to the first metal member, the groove 118 is provided closer to the battery axis side than the stepped part 115. As illustrated, the groove 118 provided in the first metal member may be a groove having an opening toward the outside when viewed along the battery axis (that is, the groove 118 may be a groove opened in a surface on a side relatively proximal to the top cover side in the member surface of the first metal member). In the illustrated aspect, such a groove 118 is provided at a non-thin site 117 (that is, other portions) positioned on the inner peripheral side of the thin portion 112. In such an aspect, the effect of reducing or avoiding the inconvenient spring back of the safety cover corresponding to the first metal member at the time of operating the safety valve can be more apparent. That is, the effect of the safety valve that reduces or avoids undesired conduction during operation of the safety valve can be more apparent. The groove 118 provided in the first metal member can also contribute to breakage and cleavage of the first metal member when the internal pressure of the battery can abnormally increases, and thus can also be referred to as a “break groove”, a “cleavage groove”, or the like. In the present disclosure, despite of a case where such a groove acts at the time of operating the safety valve, so that the safety cover 110 corresponding to the first metal member breaks and cleaves to reduce (for example, greatly reduce) the internal pressure of the can, inconvenient displacement such as spring back of the safety cover 110 after the breakage and cleavage is effectively reduced or avoided due to the stepped part 115.

In relation to the top cover, the groove of the first metal member overlaps the region of the protrusion in the battery axial direction. Preferably, the groove of the first metal member is provided at a position positioned inside the protruding region corresponding to the side portion of the protrusion of the top cover in the battery transverse direction orthogonal to the battery axial direction. With regard to such an aspect, when the separation distance R₁ of the groove 118 of the safety cover 110 corresponding to the first metal member from the battery axis P is set as the separation distance R₂ of the protruding region start point 150Cₚ (more specifically, “outer boundary 151a or 151b of the boundary between the straight portion and the curved portion in the contour in the sectional view”) of the top cover 150 from the battery axis (refer to FIG. 10), R₁<0.7R₂ may be satisfied, and for example, 0.3R₂≤R₁≤0.7R₂, 0.4R₂≤R₁≤0.7R₂, or the like may be satisfied. With such a relationship of the separation distance ratio, displacement such as inconvenient spring back of the safety cover corresponding to the first metal member at the time of operating the safety valve can be suitably reduced or easily avoided. That is, undesired conduction during operation of the safety valve is easily reduced or avoided.

In the safety valve according to the present disclosure, the second metal member may include a groove that at least contributes to suitable interruption during operation of the safety valve. In other words, the second metal member is preferably provided with a groove that contributes to breakage of the second metal member when the internal pressure of the battery can abnormally increases, that is, a cleavable groove. When such a groove is provided, breakage of the second metal member starting from the groove is likely to suitably occur when the internal pressure of the battery can abnormally increases. In the present disclosure, the groove of the second metal member may have a suitable relative positional relationship with the groove and the stepped part of the first metal member. Specifically, the groove provided in the second metal member may be positioned relatively closer to the battery axis side than the groove and the stepped part of the first metal member. That is, an interruption groove of the second metal member may be positioned on the inner peripheral side of the groove of the first metal member. Referring to FIG. 11, an interruption groove 135 in the stripper disk 130 corresponding to the second metal member is positioned relatively closer to the battery axis side than both the groove 118 (preferably, the groove 118 is provided in the non-thin site 117 positioned on the inner peripheral side of the thin portion 112) provided in the safety cover 110 corresponding to the first metal member and the “stepped part 115 including a thin portion having a thickness relatively reduced as compared with other portions”. In the safety valve having such a characteristic, the effect of reducing or avoiding the inconvenient spring back of the safety cover corresponding to the first metal member at the time of operating the safety valve can be more apparent. That is, the effect of the safety valve that reduces or avoids undesired conduction during operation of the safety valve can be more apparent.

In the battery of the present disclosure, the groove provided in the second metal member preferably has an installation position separated from the battery axis so as to act as a more suitable interruption groove in the safety valve. In a preferred aspect, while the interconnection point between the first metal member and the second metal member is positioned on the battery axis, a groove of the second metal member may be provided at a position spaced apart from the battery axis where such an interconnection point is positioned between the first metal member and the second metal member. Referring to FIG. 7, the groove 135 of the stripper disk 130 is provided at a position separated from the interconnection point J (member connection point positioned on the battery axis P) between the safety cover 110 corresponding to the first metal member and the stripper disk 130 corresponding to the second metal member. As a result, the groove provided in the second metal member is likely to suitably act as an interruption groove when the internal pressure abnormally increases, and the effect brought about by the above-described “stepped part including a thin portion having a thickness relatively reduced as compared with other portions” is more likely to become apparent. That is, the effect of reducing or avoiding the displacement of the inconvenient spring back of the safety cover corresponding to the first metal member during the operation of the safety valve is easily exhibited, and the effect of the safety valve that reduces or avoids the undesirable conduction during the operation of the safety valve can be more suitable.

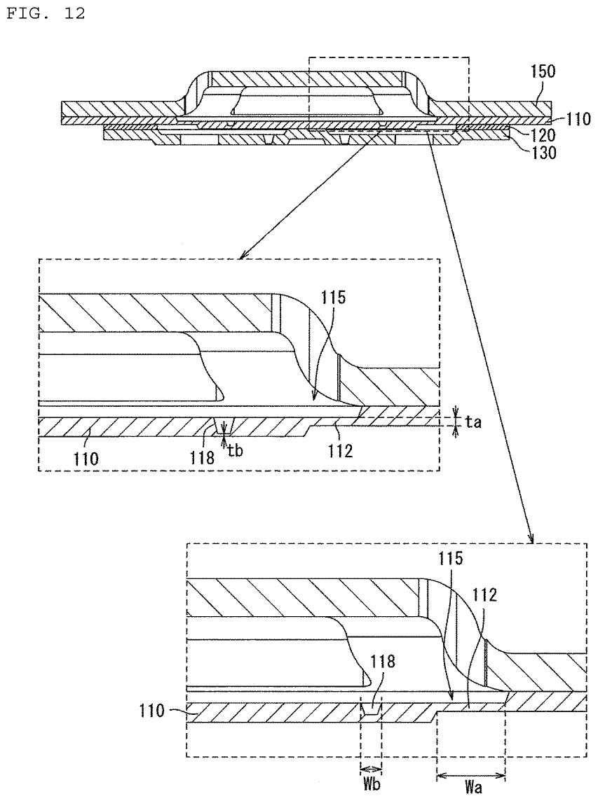

In a preferred aspect, in the first metal member, the stepped part and the groove have a suitable thickness relationship. Specifically, the thickness of the thin portion provided to the stepped part in the first metal member may be larger than the member thickness (that is, the separation distance between the bottom surface contour of the groove and the inner main surface contour of the first metal member) of the groove portion in the first metal member. Referring to FIG. 12 (the upper side of the partial enlarged view), if the thickness of the thin portion 112 forming the stepped part in the safety cover 110 corresponding to the first metal member is tₐ, and the member thickness (that is, the separation distance between the bottom surface contour of the groove and the inner main surface contour of the first metal member) in the groove 118 in the safety cover 110 is t_{b}, tₐ>t_{b} is satisfied. With such a relationship, the effect of reducing or avoiding the inconvenient spring back of the safety cover corresponding to the first metal member at the time of operating the safety valve can be more apparent. That is, the effect of the safety valve that reduces or avoids undesired conduction during operation of the safety valve can be more apparent.

In another preferred aspect, in the first metal member, the stepped part and the groove have a suitable widthwise relationship. Specifically, the width dimension of the thin portion provided to the stepped part in the first metal member may be larger than the width (for example, the groove opening dimension on the surface of the first metal member) of the groove in the first metal member. Referring to FIG. 12 (the lower side of the partial enlarged view), if the width of the thin portion 112 forming the stepped part in the safety cover 110 corresponding to the first metal member is Wa, and the member thickness (for example, the groove opening dimension on the surface side of the first metal member) in the groove 118 of the safety cover 110 is W_{b}, Wₐ>W_{b} is satisfied. With such a relationship, since the thin portion provided with the stepped part has a longer extending form, the first metal member is likely to be suitably displaced when the internal pressure is abnormally increased, and therefore, the effect brought about by the above-described “stepped part including a thin portion having a thickness relatively reduced as compared with other portions” is more likely to become apparent. That is, the effect of reducing or avoiding the displacement of the inconvenient spring back of the safety cover corresponding to the first metal member during the operation of the safety valve is easily exhibited, and the effect of the safety valve that reduces or avoids the undesirable conduction during the operation of the safety valve can be apparent.

In the safety valve according to the present disclosure, each of the safety cover corresponding to the first metal member, the stripper disk corresponding to the second metal member, and the insulating member therebetween has a disk shape or a plate shape (for example, a flat plate shape) as a whole, and as described herein, the “stepped part including a thin portion having a thickness relatively reduced as compared with other portions” is provided in the first metal member. Therefore, it can be said that a thinner structure of the safety valve (a structure having a lower safety valve height dimension) is provided while the deformation amount for the current interruption at the time of operating the safety valve is suitably secured. Due to such a reduction in thickness of the safety valve, the internal volume of the battery (electrode assembly in the exterior body) can be effectively increased while maintaining a desired safety valve function, and it can be said that a desired increase in capacity is easily realized.

A method for producing a battery according to the present disclosure will be described by employing a method for producing a secondary battery as an example. This secondary battery is produced, for example, by the following procedure.

In the production of the positive electrode, first, the positive electrode active material is, as necessary, mixed with the positive electrode binder, the positive electrode conductive agent, and the like to obtain a positive electrode mixture. Subsequently, the positive electrode mixture is dispersed in, for example, an organic solvent to obtain paste positive electrode mixture slurry. Subsequently, the positive electrode mixture slurry is applied to one surface or both surfaces of the positive electrode current collector and then dried to form a positive electrode active material layer. Thereafter, the positive electrode active material layer is compression-molded using a roll press or the like, if necessary. In this case, the positive electrode active material may be heated, or compression molding may be repeated multiple times. In the same manner, a negative electrode can be produced. Specifically, the negative electrode active material, and, for example, a negative positive electrode binder and the negative electrode conductive agent are mixed to obtain a negative electrode mixture. Subsequently, the negative electrode mixture is dispersed in, for example, an organic solvent to obtain paste negative electrode mixture slurry. Then, the negative electrode mixture slurry is applied to one surface or both surfaces of the negative electrode current collector and then dried to form a negative electrode active material layer. Thereafter, the negative electrode active material layer is compression-molded using a roll press or the like, if necessary.

In the case of assembling a secondary battery, for example, the positive electrode lead is connected to the positive electrode current collector by a welding method and the like as well as the negative electrode lead is connected to the negative electrode current collector by a welding method and the like. Subsequently, the positive electrode and the negative electrode are stacked with the separator interposed therebetween, and then, the positive electrode, the negative electrode, and the separator are wound to form the wound electrode body. Subsequently, the center pin is inserted in the winding space of the wound electrode body. Then, the wound electrode body is sandwiched between a pair of insulating plates, and is contained inside the battery can together with the pair of insulating plates. In this case, one end of the positive electrode lead is coupled to the safety valve by, for example, a welding method, and similarly, one end of the negative electrode lead is coupled to the battery can by, for example, a welding method. Next, an electrolytic solution is injected into the battery can, and the wound electrode body is impregnated with the electrolytic solution. Finally, a safety valve is provided at the opening end portion of the battery can with, for example, a holder member interposed therebetween. Thereby, a secondary battery provided with the safety valve is completed.

The groove (that is, “stepped part including a thin portion having a thickness relatively reduced as compared with other portions”) provided in the first metal member according to the present disclosure can be provided at the time of press die molding of the first metal member. In addition, the stepped part can be formed not only by press molding but also by other methods such as mechanical grinding and laser processing.

Although embodiments of the present disclosure have been described herein, in the safety valve provided in the present disclosure, as described herein, the first metal member, the second metal member, and the insulating member are combined so as to be stacked together with the top cover, the first metal member, the second metal member, and the insulating member are plate-like or disk-like members, the insulating member has a hollow portion or a cavity, and the first metal member and the second metal member are connected with the hollow portion or the cavity of the insulating member interposed therebetween. Such a configuration at least results in a thin safety valve, and in combination with the feature of the “stepped part including a thin portion having a thickness relatively reduced as compared with other portions”, inconvenient displacement such as spring back of the safety cover corresponding to the first metal member during operation of the safety valve is suitably reduced or easily avoided (that is, undesired conduction during operation of the safety valve is easily reduced or avoided). Note that embodiments of the present disclosure described herein are merely exemplary. Therefore, the present disclosure is not limited to those embodiments, and those skilled in the art will readily understand that various aspects can be conceived.

For example, although the cylindrical battery has been described herein, the present disclosure is not necessarily limited thereto. For example, the battery according to the present disclosure may be a battery having another shape such as a prismatic battery, and the effect of the present disclosure can be similarly exhibited.

In the above description, the battery can, that is, the exterior body of the battery has been mentioned in the description of the present disclosure, but such an exterior body may have a beadless structure without a beading portion. Since the beadless exterior body does not have a narrowed or constricted portion inside the exterior body (particularly, near the battery axis side), it is possible to secure a wider space for arranging the electrode assembly inside the exterior body. That is, a beadless exterior can or the like in which the inner diameter dimension of such a battery can is substantially constant along the battery axis can contribute to realization of a battery having a higher energy density.

Furthermore, for example, in the safety valve according to the present disclosure, the groove (interruption groove) provided in the second metal member may be provided together with the opening part adjacent thereto. That is, an opening part may be provided in the second metal member, and the opening part and the groove may be adjacent to each other in the second metal member to form the interruption site. In other words, the interruption site (that is, the interruption site that acts when the internal pressure of the battery can abnormally increases) may be formed in a relationship in which the groove and the opening part are adjacent to each other, preferably in a relationship in which they are directly adjacent to each other. In such a case, the groove and the opening part may be arranged adjacent to each other so that an annular contour is formed from the groove and the opening part, and preferably, may be arranged alternately adjacent to each other.

Aspects of the secondary battery of the present disclosure are as follows according to an embodiment.
<1> A battery (for example, a primary battery or a secondary battery) including:
a safety valve (or a safety valve structure, a battery safety valve or a safety valve structure),
in which the safety valve includes a first metal member positioned on an outer side, a second metal member positioned on an inner side, and an insulating member positioned between the first metal member and the second metal member,
the first metal member and the second metal member are connected to each other so as to straddle the insulating member, and
the first metal member has a stepped part (that is, a stepped part configured together with a thin form having a relatively reduced thickness) including a thin portion (thin site) having a thickness relatively reduced as compared with the other portion (non-thin site).
<2> The battery according to <1>, in which in a sectional view of the safety valve, the stepped part is provided such that the outer contour of the first metal member has a stepped contour and the inner contour of the first metal member also has a stepped contour.
<3> The battery according to <1> or <2>, in which in the safety valve, the first metal member, the second metal member, and the insulating member are combined so as to be stacked together with the top cover, the first metal member, the second metal member, and the insulating member are plate-like or disk-like members, the insulating member has a hollow portion or a cavity, and the first metal member and the second metal member are connected with the hollow portion or the cavity of the insulating member interposed therebetween.

<4> The battery according to any one of <1> to <3>, further including: a top cover provided further outside than the first metal member, the top cover having a protrusion protruding outward, in which the stepped part of the first metal member and a protruding region of the protrusion of the top cover have a positional relationship in which the stepped part and the protruding region overlap each other.
<5> The battery according to any one of <1> to <4>, in which the first metal member further includes a groove positioned relatively closer to the battery axis side than the stepped part.
<6> The battery according to <5>, in which a groove is provided in the second metal member, and the groove of the second metal member is positioned relatively closer to the battery axis side than the groove and the stepped part of the first metal member.
<7> The battery according to <6>, in which an interconnection point between the first metal member and the second metal member is positioned on a battery axis, and the groove of the second metal member is provided at a position separated from the battery axis.
<8> The battery according to any one of <1> to <7>, in which in the first metal member, a thin thickness dimension of the thin portion has a thickness ratio of 0.7 or less to a non-thin thickness dimension of the other portion.
<9> The battery according to any one of <1> to <8>, in which the insulating member is made of a resin material.
<10> The battery according to any one of <1> to <9>, in which the battery includes a positive electrode and a negative electrode capable of occluding and releasing lithium ions.

The battery (battery such as a primary battery or a secondary battery) according to the present disclosure can be typically used for applications in which use of electric energy is required according to an embodiment. For example, a secondary battery according to the present disclosure can be used in various fields in which electric storage is assumed. The battery of the present disclosure can be used in the fields of electricity, information, and communication in which electrical/electronic equipment and the like are used (for example, the fields of electrical/electronic equipment and mobile equipment including mobile phones, smartphones, notebook computers, digital cameras, activity meters, arm computers, electronic paper, wearable devices, and small electronic machines such as RFID tags, card type electronic money, and smartwatches), home and small industrial applications (for example, the fields of electric tools, golf carts, and home, nursing, and industrial robots), large industrial applications (for example, the fields of forklifts, elevators, and harbor cranes), transportation system fields (for example, the fields of hybrid vehicles, electric vehicles, buses, trains, power-assisted bicycles, electric two-wheeled vehicles), power system applications (for example, the fields of various types of power generation, road conditioners, smart grids, and household power storage systems), medical applications (the field of medical equipment such as earphone hearing aids), pharmaceutical applications (the fields of dosage management systems and the like), IoT fields, space and deep sea applications (for example, the fields of space probes and submersibles), and the like, as merely examples.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising:
a safety valve,
wherein the safety valve includes a first metal member positioned on an outer side, a second metal member positioned on an inner side, and an insulating member positioned between the first metal member and the second metal member,
the first metal member and the second metal member are connected to each other so as to straddle the insulating member, and
the first metal member has a stepped part including a thin portion having a thickness relatively reduced as compared with other portions.

2. The battery according to claim 1, wherein in a sectional view of the safety valve, the stepped part is provided such that the outer contour of the first metal member has a stepped contour and the inner contour of the first metal member also has a stepped contour.

3. The battery according to claim 1, wherein in the safety valve, the first metal member, the second metal member, and the insulating member are combined so as to be stacked together with the top cover, the first metal member, the second metal member, and the insulating member are plate-like or disk-like members, the insulating member has a hollow portion or a cavity, and the first metal member and the second metal member are connected with the hollow portion or the cavity of the insulating member interposed therebetween.

4. The battery according to claim 1, further comprising a top cover provided further outside than the first metal member, the top cover having a protrusion protruding outward,
wherein the stepped part of the first metal member and a protruding region of the protrusion of the top cover have a positional relationship in which the stepped part and the protruding region overlap each other.

5. The battery according to claim 1, wherein the first metal member further includes a groove positioned relatively closer to the battery axis side than the stepped part.

6. The battery according to claim 5, wherein a groove is provided in the second metal member, and the groove of the second metal member is positioned relatively closer to the battery axis side than the groove and the stepped part of the first metal member.

7. The battery according to claim 6, wherein an interconnection point between the first metal member and the second metal member is positioned on a battery axis, and the groove of the second metal member is provided at a position separated from the battery axis.

8. The battery according to claim 1, wherein in the first metal member, a thin thickness dimension of the thin portion has a thickness ratio of 0.7 or less to a non-thin thickness dimension of the other portion.

9. The battery according to claim 1, wherein the insulating member is made of a resin material.

10. The battery according to claim 1, wherein the battery includes a positive electrode and a negative electrode capable of occluding and releasing lithium ions.
